(19) United States
(12) Patent Application Publication
(10) Pub. No.: US 2008/0236024 A1
(43) Pub. Date: Oct. 2, 2008

(54) Humane trap for animals

(76) Inventor: Aurele Ouellette, Lac Des Ecorces (CA)

Correspondence Address: INVENTARIUM, SUITE 1607, 4050, ROSEMONT, MONTREAL, QC, H1X 1M4, CA

(21) Appl. No.: 12/046,516

(22) Filed: Mar. 12, 2008

Related U.S. Application Data
(60) Provisional application No. 60/920,152, filed on Mar. 27, 2007.

(51) Int. Cl. A01M 23/36

(52) U.S. Cl. 43/81

(57) ABSTRACT

A humane trap has a body with a lid at one end and an open end at the opposite end of the body thereof. A pair of coil springs have one end attached to the body and the opposite end attached to a strike retainer. The strike retainer having a strike extending integrally therefrom. The strike retainer and the strike rotating around an axis. A trigger rotationally attached to the body has a latch release part which releases a latch hooked into the latch release part. The latch releases the strike retainer. The strike retainer releases the strike.

This application claims priority based on provisional application 60/920,152 filed Mar. 27, 2007

### FIELD OF THE INVENTION

The present invention relates generally to traps but more particularly to humane traps used for animals.

### BACKGROUND OF THE INVENTION

There exists a wide variety of traps which are generally grouped into three categories, those that kill instantly, those that injure, and those that keep the animal inside a cage without, presumably, hurting the animal.

The term “humane” trap refers to those that won't have the animal suffer by killing it instantly.

A lot of times, several hours if not days pass between the time an animal is trapped and the time the animal is retrieved by the trapper, that is why a trap that kills instantly is preferred by trappers.

One inconvenient with traps is that often, these traps are used in wintertime in snow which can easily and quickly rust some mechanical parts. Although care is taken to use corrosion resistant materials as much as possible, it is not always possible for various reasons such as cost and reliability of corrosion free materials, especially metal fatigue which can render inefficient some materials even through they are not damaged by rust.

There is therefore a need for improvement in traps.

### SUMMARY OF THE INVENTION

In view of the foregoing disadvantages inherent in the known devices now present in the prior art, the present invention, which will be described subsequently in greater detail, is to provide objects and advantages which are:

To provide for a relaible trap having easily accessible and removable parts to facilitate maintenance and replacement of parts.

In order to do so, the invention comprises a body with a lid at one end and an open end at the opposite end of the body thereof A pair of coil springs have one end attached to the body and the opposite end attached to a strike retainer.

The strike retainer having a strike extending integrally therefrom. The strike retainer and the strike rotating around an axis. A trigger rotationally attached to the body has a latch release part which releases a latch hooked into the latch release part. The latch releases the strike retainer. And, the strike retainer releases the strike.

A humane trap has a method of operation consisting in the steps of having an animal entering the opened end of the body and pushing the trigger, the trigger releases the strike and the animal is killed.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Perspective view of the device.

FIG. 2 Side view of the device.

FIG. 3 Top view of the device.

FIG. 4 Front view of the device.

FIG. 5 Side view of an alternate embodiment of the device.

FIG. 6 Top view of an alternate embodiment of the device.

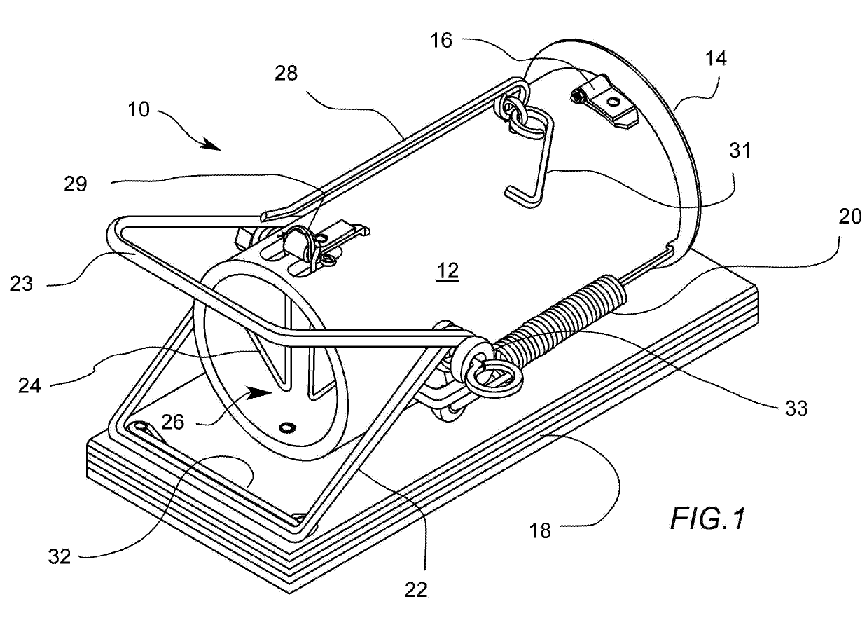

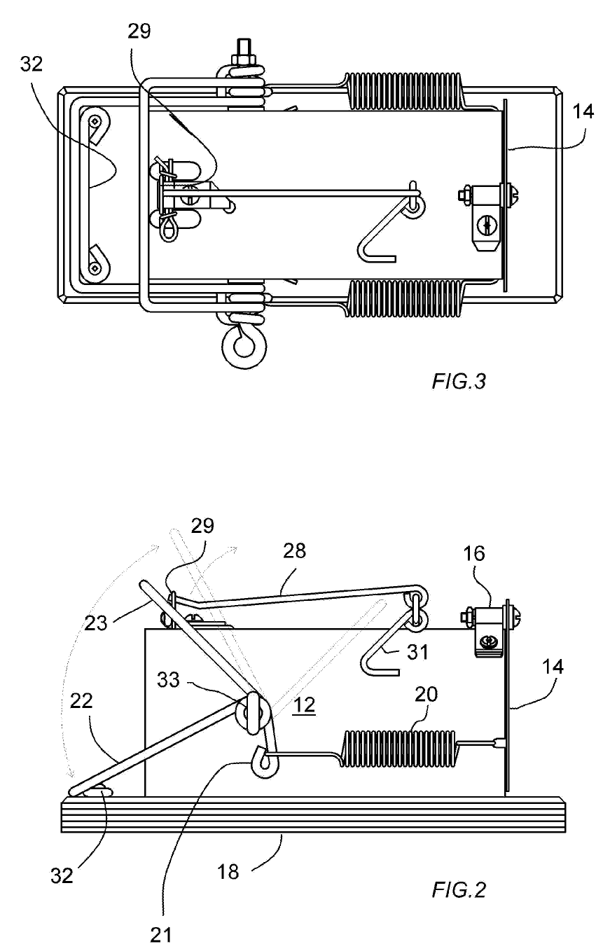

### DETAILED DESCRIPTION

A humane trap (10) has a body (12) into which an animal (not shown) enters. Bait is put inside the body (12) so as to attract the animal, as is known in the art. The bait can be placed inside the body (12) by opening a lid (14) equipped with a hinge (16) fixedly attached to the body (12). the body (12) is itself fixedly attached to a base (18). Located on the exterior of the body (12) are all the elements which make the trap (10) functional. A pair of coil springs (20) have one end attached to the body (12) while their opposite end is attached to a strike lever (21). A strike (22) and a strike retainer (23) cooperate in order to make the invention functional as will be explained hereinbelow.

A trigger (24), rotationally aattached to the body (12), is triggered, when an animal (not shown) enters the opened end (26) of the body (12), and pushes the trigger (24) which moves a latch release part (29)—which is an integral part of the trigger (24)—which releases a latch (28) that then releases the strike retainer (23). Releasing the strike retainer (23) automatically releases the strike (22), since both components are essentially one continuous piece joining around an axis (33) around which they rotate. The strike retainer (23) and the strike (22), when released, are biased downwards by way of a pair of coil springs (20). The coil springs (20) are held under tension until the latch (28) releases the strike retainer (23).

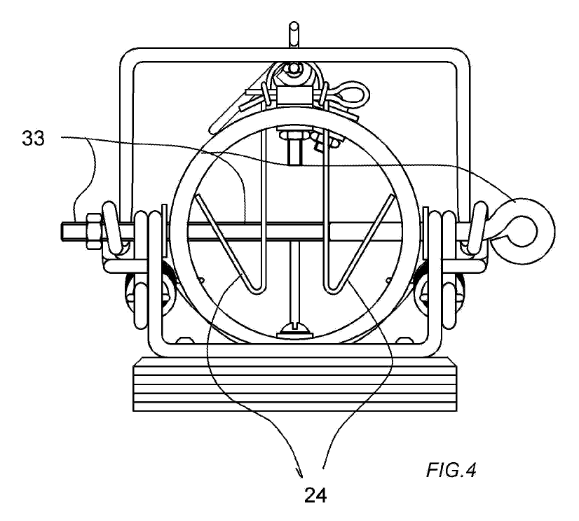

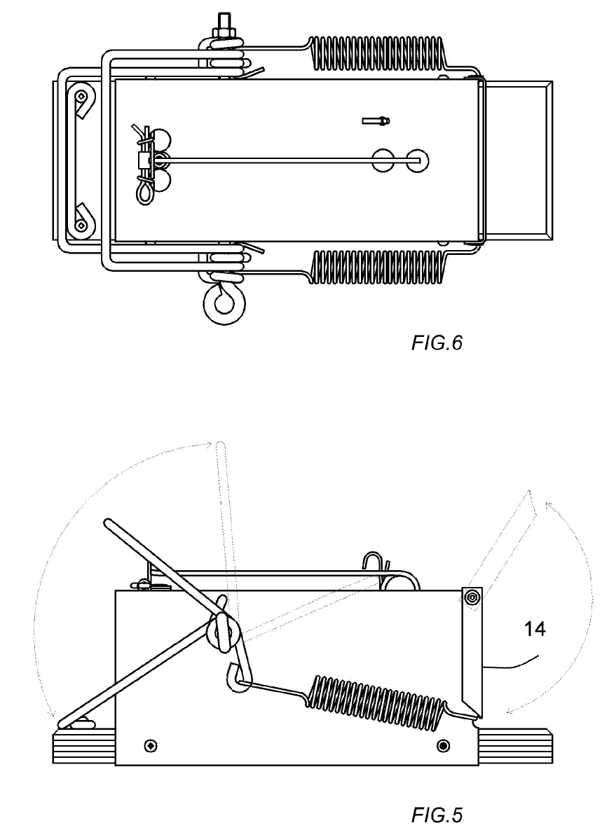

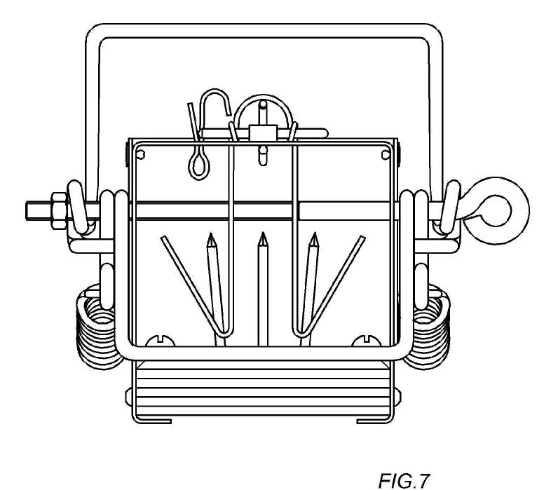

FIGS. 5-7 show an alternate embodiment wherein the main difference is that the body (12) is generally rectangular (as seen from FIG. 7) instead of circular (as seen from FIG. 4).

Other components include a blade (32), thus named not so much because it is sharp but rather because it provides a hard a thin surface that insures a clean break of the neck as well as a better retaining means of the animal onto the trap (10). A clip (31) holds the strike retainer (23) under tension while preventing an accidental release, for use when initially setting up the trap (10) or when moving it around and such.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A humane trap comprising:
a body with a lid at one end and an open end at the opposite end of the body thereof;
a pair of coil springs have one end attached to the body and the opposite end attached to a strike retainer;
the strike retainer having a strike extending integrally therefrom;
the strike retainer and the strike rotating around an axis;
a trigger rotationally attached to the body has a latch release part which releases a latch hooked into the latch release part;
the latch releases the strike retainer;
the strike retainer releases the strike.

2. A humane trap as in claim 1 having the method of operation consisting in the steps of:
when an animal enters the opened end of the body and pushes the trigger, the trigger releases the strike and the animal is killed.
